(19) United States
(12) Patent Application Publication
(10) Pub. No.: US 2006/0210947 A1
(43) Pub. Date: Sep. 21, 2006

(54) ENDODONTIC INSTRUMENT AND INSTRUMENT SYSTEM

(76) Inventor: Christopher J. Lampert, Lake Oswego, OR (US)

Correspondence Address: GANZ LAW, P.C., P O BOX 2200, HILLSBORO, OR, 97123, US

(21) Appl. No.: 11/422,577

(22) Filed: Jun. 6, 2006

Related U.S. Application Data
(63) Continuation-in-part of application No. 10/756,599, filed on Jan. 12, 2004.
(60) Provisional application No. 60/687,297, filed on Jun. 6, 2005.
(60) Provisional application No. 60/439,479, filed on Jan. 13, 2003.

(51) Int. Cl. A61C 5/02

(52) U.S. Cl. 433/102

(57) ABSTRACT

An endodontic file comprising an elongated, flexible metal, the file having a working portion for cutting or abrading biological material, the working portion comprising a proximal portion and a distal portion, the proximal and distal portions having different cross-sectional flute or core patterns and associated cutting edges.

This application is a Continuation-in-Part of U.S. Ser. No. 10/756,599, filed Jan. 12, 2004, entitled ENDODONTIC INSTRUMENT AND INSTRUMENT SYSTEM, which claims the benefit of and priority to U.S. Provisional Application No. 60/439,479, entitled “ENDODONTIC INSTRUMENT”, filed Jan. 13, 2003, the entire disclosures of which are hereby incorporated by reference as if set forth in their entirety for all purposes. This application also claims the benefit of and priority to U.S. Provisional Application Ser. No. 60/687,297, filed Jun. 6, 2005, entitled ENDODONTIC INSTRUMENT WITH MULTIPLE FLUTE PATTERNS, the contents of which are hereby incorporated by reference as if set forth in its entirety for all purposes.

### BACKGROUND

This invention relates generally to endodontic instruments known as endodontic files, used by dentists when performing root canal procedures. A root canal procedure is a common dental procedure for treating or preventing a dental abscess. During a root canal procedure, the infected nerve and pulpal tissue are removed from the root canal of the involved tooth. The root canal is then cleaned by shaping or reaming the root canal with endodontic files to produce a clean environment to receive a root canal filling material. The standard filling material, which has been used for over fifty years, is an inert material called gutta-percha.

Endodontic files are used to remove the contents of the root canal and to prepare or shape the root canal prior to filling it. Endodontic files may be designed to be manually manipulated by the fingers of a dentist or to be engine driven by a rotating hand piece, which rotates the file during use. Endodontic files typically consist of a tapered distal working portion containing a plurality of helical spiraled flutes, a shaft portion located proximal to the working portion, and a handle located on the proximal end of the instrument. The flutes form planing or cutting surfaces, which dislodge and remove the infected tissue within the root canal being treated. For all currently available tapered endodontic files the helical or spiral flutes turn continuously along the entire working portion of the file.

FIGS. 1 and 2 show a prior art endodontic file 10 that is representative of the type currently in use. File 10 includes a handle 12 at a proximal end 14, a shaft portion 16, and a working portion 18 that tapers toward a distal end 20. Working portion 18 is formed of a plurality of helical or spiral flutes 22 that form cutting surfaces 24 (also known as radial lands) supporting cutting edges, as seen most clearly in the cross-sectional view of FIG. 2. Flutes 22 extend continuously along working portion 18. File 10 may be manipulated by hand or be engine driven to rotate so that the edges of cutting surfaces 24 remove infected tissue from the root canal.

Because root canals are seldom straight, but usually curved or twisted in multiple planes, it is important that endodontic files be flexible so that the file can follow the curved canal to its terminus during the cleaning process. Another advantage to having endodontic files with enhanced flexibility is that file breakage during the cleaning process of the root canal is greatly reduced. The recognized need for flexible endodontic files has led to the use of nickel-titanium alloys as the preferred material of choice for constructing endodontic files.

Understanding that file breakage during a root canal procedure is an undesired event and its prevention is critical to a successful root canal procedure, providing an endodontic file with a resistance to breakage would be of great benefit to the field of endodontics.

File breakage generally occurs from two causes. The first cause is cyclic fatiguing of the instrument material caused by repeated bending of the file. The incidence of cyclic fatigue file breakage is inversely related to file flexibility, therefore as instrument flexibility increases, cyclic fatigue file breakage decreases. The second cause of file breakage is the application of excessive torque to the endodontic file leading to torque failure. Such excessive torque is caused, at least in part, by the fact that substantially the entire length of the file working portion is in contact with the canal wall.

Some current cleansing and shaping techniques used to prepare the root canal employ numerous endodontic files having a continuously tapered helical fluted working portion. The numerous files used during a root canal procedure may have different tip diameter sizes and/or tapers to allow the different files to clean different regions of the root canal. However, such current endodontic files encounter the problems discussed above.

The following patents relate to existing endodontic instruments and/or methods of manufacturing: U.S. Pat. Nos. 6,968,619, 4,934,934; 5,464,362; 5,628,674; 5,653,590; and 6,074,209. All the foregoing patents are hereby incorporated by reference in their entireties for all purposes.

It would be an improvement in the art of endodontics to provide an endodontic file that has enhanced flexibility to reduce the likelihood of breakage. It would be a further improvement to provide an endodontic file having limited or dedicated cutting regions along the working portion of the file to limit the root canal surface area that is engaged by the endodontic file and to control which portion of the root canal is shaped and/or prepared. Decreasing the surface area of the endodontic file in contact with the root canal wall would effectively reduce the frictional torque applied to the instrument and would decrease the incidence of torque failure breakage

### SUMMARY

As will be appreciated by persons skilled in the art from the teachings herein, the inventive subject matter disclosed herein contemplates novel endodontic files for shaping and/or preparing a root canal during a root canal procedure wherein there are variable cutting properties along the working portion of the shaft to achieve desired properties for cutting, debris removal, strength, flexibility, and/or other operational parameters.

The files disclosed herein generally have a proximal shaft portion connected to a handle portion and a distal working portion. The file may be manipulated by the fingers of an operator or inserted into a rotary engine driven hand piece.

In certain embodiments, working portion of the file may include novel arrangements of multiple tapered cutting segments separated by non-cutting segments. The cutting segments have a cutting edge formed by a plurality of helical flutes. Each non-cutting segment preferably has a diameter that is significantly smaller than the diameter of the adjacent cutting segments. This arrangement provides overall flexibility of the file and increases the resistance to cyclic fatigue breakage. This arrangement further controls or limits which areas of the root canal are shaped and/or prepared during file use. The non-cutting segments limit the surface area of the root canal that is engaged by the cutting segments of the file. The cutting segments are located and arranged along the working portion to control which portion of the file actively shapes and/or prepares the root canal. The cutting segments may have a substantially continuous taper. Alternatively, the taper of each cutting segment may vary.

In other possible embodiments, the cutting segments may have a non-circular geometric configuration and may be formed as straight and oriented substantially parallel to the long axis of the file rather than formed as helical or spiraling cutting segments. Such embodiments prevent the file from self-feeding into the root canal.

In other possible embodiments, an endodontic file forms part of a series of endodontic files to shape and/or prepare a root canal. Each file in the series may use novel files disclosed herein. For example, two or more files in a set may have cutting segments and non-cutting segments strategically placed in different regions along the working portion of the file to allow each file in the system to shape and/or prepare different portions of the root canal.

The present invention provides an endodontic file for use in root canal treatment in which the cutting segments are located along the working portion in a manner to correspond with a portion of a root canal that is to be actively cut. For example, the cutting segments and non-cutting segments may be of any length and may by of any number.

In certain embodiments, the non-cutting segments may have a diameter that is substantially less than the diameter of the cutting segments in order to provide flexibility and to control which region of the root canal is shaped or prepared by the file.

To illustrate still further embodiments consistent with the principle of providing a working shaft with variable properties along the working shaft, a working shaft may have at least two different cross-sectional core or flute patterns along the working portion of the file. For example, the cutting flutes on the distal end of the working portion may have a radial landed “U-shaped” cross sectional design and the flutes on the proximal end may have a non-radial landed “triangular-shaped” cross sectional design. Any combination of multiple cross sectional flute geometries, radial landed or non-radial landed, may exist on the working portion.

These and other embodiments are described in more detail in the following detailed descriptions and the figures.

The foregoing is not intended to be an exhaustive list of embodiments and features of the present invention. Persons skilled in the art are capable of appreciating other embodiments and features from the following detailed description in conjunction with the drawings.

### BRIEF DESCRIPTION OF THE DRAWINGS

FIG. 1 is a view of a prior art endodontic file.

FIG. 2 is a cross-sectional view of the endodontic file of FIG. 1 taken along line A-A.

FIG. 3 is a view of one embodiment of an endodontic file according to the inventive subject matter disclosed herein having multiple tapered cutting sections.

FIG. 4 is a view of another inventive embodiment of an endodontic file of the present invention having a non-cutting section at the distal end of the file.

FIG. 5 is a view of another inventive embodiment of an endodontic file having straight cutting sections.

FIG. 6 is a cross-sectional view of the endodontic file of FIG. 5 taken along line B-B.

FIG. 7 is a view of an inventive endodontic file system comprised of plural endodontic files each having cutting sections located at different locations along the working portion of the file.

FIG. 8 is a view of another inventive embodiment of an endodontic file system showing an alternative arrangement of cutting sections along the working portion of the file.

FIG. 9 is a view of another inventive embodiment of an endodontic file in which each cutting segment has a different taper.

FIG. 10 is an illustration of another inventive embodiment of an endodontic file.

FIG. 11 is an illustration of the cross-sectional flute pattern through line B-B of FIG. 10.

FIG. 12 is an illustration of the cross-sectional flute pattern through line C-C of FIG. 10.

FIGS. 13-20 are each illustrations of example cross-sectional flute patterns according to the inventive subject matter disclosed herein.

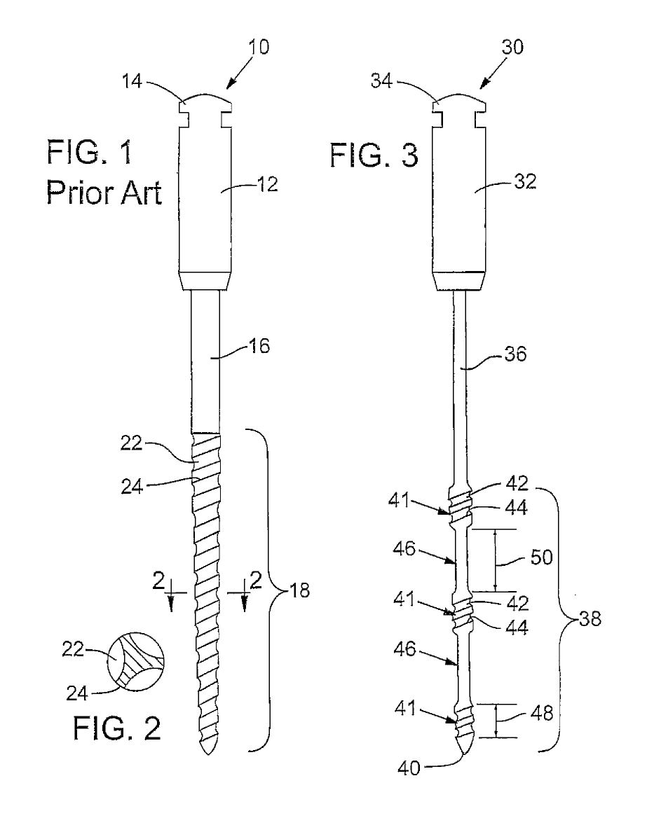

### DETAILED DESCRIPTION OF THE INVENTION

Certain representative embodiments of the present invention are shown in FIGS. 3-9, wherein similar features share common reference numerals.

FIG. 3 shows one embodiment of an endodontic file 30 of the present invention. File 30 may include a handle 32 located at a proximal end 34, a shaft 36, and a working portion 38 extending to a distal end 40. Working portion 38 may be formed of a plurality cutting segments 41 formed of helical or spiral flutes 42 that form cutting edges 44 and separated by non-cutting segments 46. Cutting segments 41 may be of any desired shape but are shown in this embodiment as being tapered in a direction from proximal end 34 toward distal end 40. Non-cutting segments 46 are shown in this embodiment to have a smooth circular cross-section having a diameter that is less than the diameter of the adjacent cutting segments 41. The relationship between cutting segments 41 and non-cutting segments 46 provide flexibility to file 30 to eliminate or reduce the chance of breakage as working portion 38 follows any curved and/or twisted portions of the root canal.

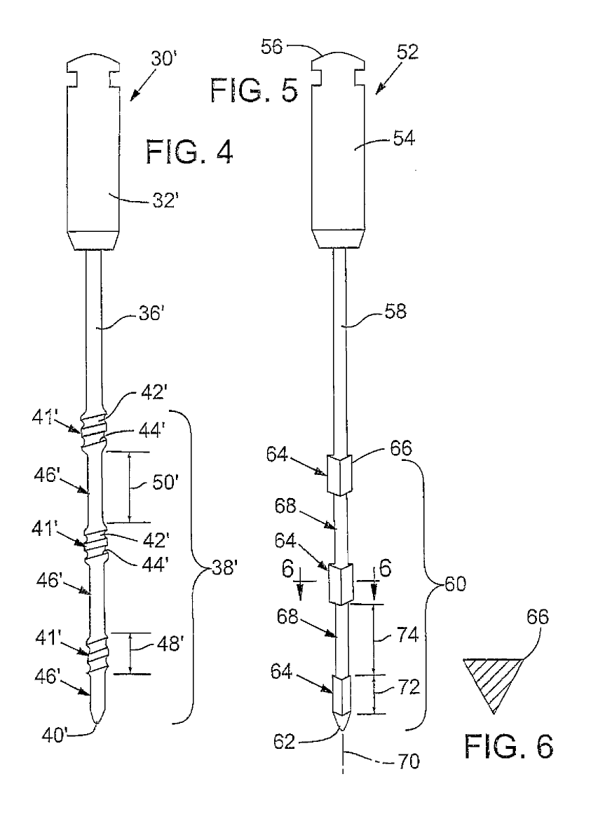

In addition to providing flexibility, file 30 provides control over which portion or portions of the root canal are shaped and/or prepared. This is accomplished by the location of cutting segments 41 along working portion 38. Cutting segments 41 may be located along working portion 38 at selected locations depending on which areas of the root canal are to be shaped and/or prepared. For example, in the embodiment of FIG. 3, only the portions of the root canal adjacent cutting segments 41 are shaped and/or prepared. The embodiment of file 30 shown in FIG. 3 shows cutting segments 41 located along working portion 38 in a spaced arrangement in which a cutting segment 41 is located at distal end 40. FIG. 4 shows another embodiment of an endodontic file similar to file 30 of FIG. 3 in which like parts will be given like reference numbers indicated with a prime (′). Thus, file 30′ includes cutting segments 41′ located and arranged along working portion 38′ so that a non-cutting segment 46′ is located at distal end 40′. It should be further noted that other aspects of working portion 38, 38′ may vary. For example, although only three cutting segments 41, 41′ are shown in FIGS. 3 and 4, the number of cutting segments 41, 41′ may vary. Additionally, the length 48, 48′ of cutting segments 41, 41′ and/or the length 50, 50′ of non-cutting segments 46, 46′ may vary.

FIGS. 5 and 6 show another embodiment of a file 52 that includes a handle 54 located at a proximal end 56, a shaft portion 58, and a working portion 60 extending to a distal end 62. Working portion 60 may be formed of a plurality cutting segments 64 each having a geometrical shape that forms a cutting edge 66 and separated by non-cutting segments 68. In this embodiment, cutting segments 64 may have a non-circular shape and are shown as being triangular in cross section, which core structure is shown in FIG. 6. However, it should be understood by those skilled in the art that the invention is not limited to cutting segments having a triangular shape and that other geometric shapes may be contemplated. Preferably, the geometric shape of cutting segments 64 form cutting edges 66 that are substantially parallel to the long axis 70 of file 52. Non-cutting segments 68 are shown in this embodiment to have a smooth circular cross-section having a diameter that is less than the cross-sectional shape of the adjacent cutting segments 64. Cutting segments 64 have a length 72 and non-cutting segments 68 have a length 74 both of which may vary. The relationship between cutting segments 64 and non-cutting segments 68 provide flexibility to file 30 to eliminate or reduce the chance of breakage as working portion 60 follows any curved and/or twisted portions of the root canal.

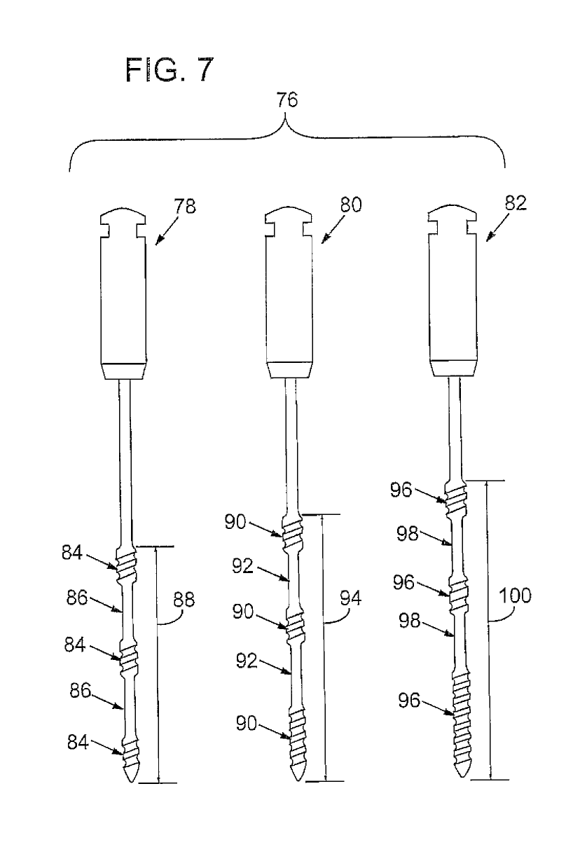

FIG. 7 shows a file system 76 that includes a series of individual files 78, 80, and 82 being of substantially equal length, each file having cutting segments and non-cutting segments strategically located along the file to allow each file to shape and/or prepare a different region of the root canal and to divide the workload of shaping and/or preparing the root canal among the files in the file system 76. For example, in the embodiment shown in FIG. 7, file 78 may include multiple cutting segments 84 separated by non-cutting segments 86 located along working portion 88. File 80 may include cutting segments 90 and non-cutting segments 92 located along working portion 94. Working portion 94 extends over a greater portion of file 80 than working portion 88 of file 78. Additionally, the lengths of cutting segments 90 and non-cutting segments 92 may vary so that they may overlap with cutting segments 84 and non-cutting segments 86 of file 78. File 82 may have cutting segments 96 and non-cutting segments 98 located along working portion 100, which extends over a greater portion of file 82 than working portion 94 of file 80 or working portion 88 of file 78. In a manner similar to files 78 and 80, the length of cutting segments 96 and non-cutting segments 98 may vary so that they may overlap with cutting segments 90 and non-cutting segments 92 of file 80 and cutting segments 84 and non-cutting segments 86 of file 78. The cutting segments 84, 90, 96 of individual files 78, 80, 82 are arranged so that, when taken together, they effectively form one continuous cutting segment covering the entire working portion 100.

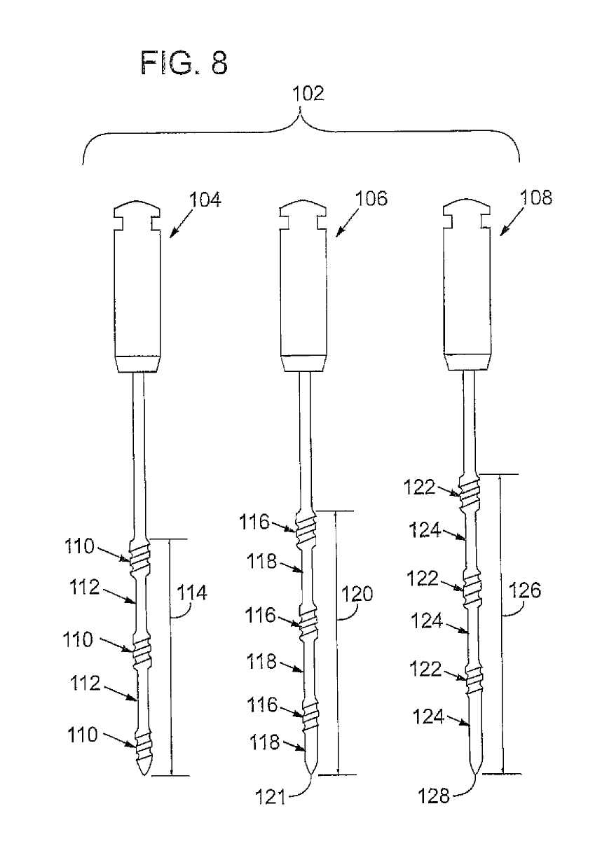

FIG. 8 shows an alternative file system 102 that includes a series of individual files 104, 106, and 108 being of substantially equal length. Similar to files 78, 80, 82 in FIG. 7, each file 104, 106, 108 have cutting segments and non-cutting segments strategically located along the file to allow each file to shape and/or prepare a different region of the root canal and to divide the workload of shaping and/or preparing the root canal among the files in the file system 102. However, the cutting segments and non-cutting segments of files 104, 106, 108 are arranged in an alternative manner. For example, file 104 may include multiple cutting segments 110 separated by non-cutting segments 112 located along working portion 1 14. File 106 may include cutting segments 116 and non-cutting segments 118 located along working portion 120 so that a non-cutting segment 118 is located at distal end 121. Working portion 120 extends over a greater portion of file 106 than working portion 114 of file 104. Additionally, the lengths of cutting segments 116 and non-cutting segments 118 may vary so that they may overlap with cutting segments 110 and non-cutting segments 112 of file 104. File 108 may have cutting segments 122 and non-cutting segments 124 located along working portion 126, which extends over a greater portion of file 108 than working portion 120 of file 106 or working portion 114 of file 104. A non-cutting segment 124 is located at a distal end 128. In a manner similar to files 104 and 106, the length of cutting segments 122 and non-cutting segments 124 may vary so that they may overlap with cutting segments 116 and non-cutting segments 118 of file 106 and cutting segments 110 and non-cutting segments 112 of file 104. The cutting segments 110, 116, 122 of individual files 104, 106, 108 are arranged so that, when taken together, they effectively form one continuous cutting segment covering the entire working portion 126. The staggered cutting segments and non-cutting segments of the files of each system 76, 102 have been described as overlapping. However, it is within the scope of this invention that the staggered cutting segments of the related files in each system 76, 102 do not overlap. Regardless of whether or not the cutting segments overlap the files in both systems 76, 102, when taken together, form a cutting segment along the entire working portion.

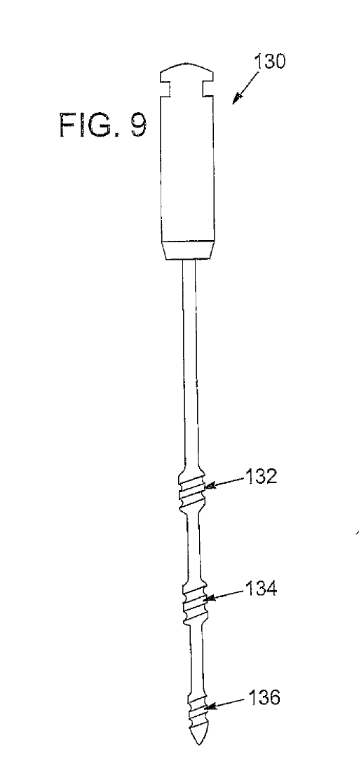

FIG. 9 shows an alternative embodiment for a file 130 having variable tapered cutting segments for added flexibility. In this embodiment, the percentage taper of one cutting segment may be different from the percentage taper of the other cutting segments. For example, first cutting segment 132 may have an 8% taper, second cutting segment 134 may have a 6% taper, and third cutting segment 136 may have a 4% cutting taper.

It should be understood by those skilled in the art that either file system 76, 102 may be comprised of files having tapered cutting segments, variable tapered cutting segments, or geometrically shaped cutting segments.

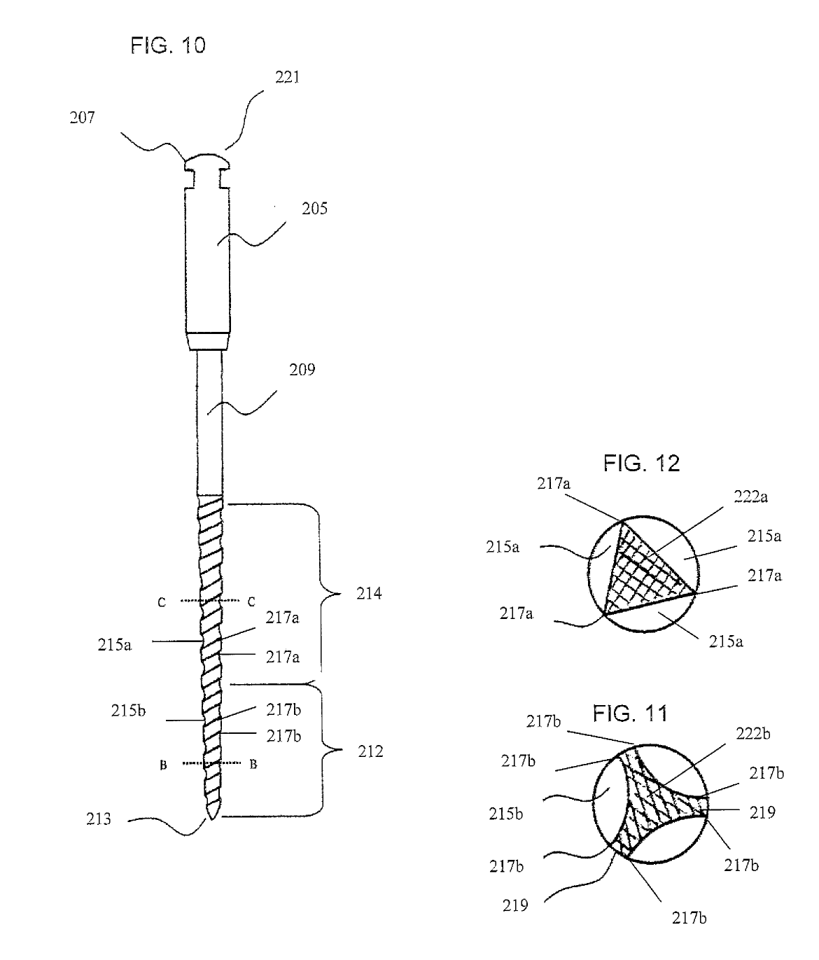

FIGS. 10-20 illustrate still further how at least two different cross-sectional flute patterns of any shape may exist on the working portion. FIG. 10 shows the present inventive file 221 with two different cross-sectional flute or core patterns (222a and 222b) located contiguously along long axis of the working portion of the file. Proximal working portion 214 has a different cross-sectional flute pattern than the distal working portion 212. The cross-sectional flute pattern for distal working portion 212 is shown in FIG. 11, which is taken through line B-B. The cross-sectional flute pattern for working portion 214 is shown in FIG. 12, which is taken through line C-C. (In these and other cross-sectional views in the Figures, the circle drawn around the illustrated structure is not intended to represent additional structure, but rather illustrates the radial area capable of being cut by the encircled core structure, consistent with how those in the art illustrate endodontic file cross-sections.) The cross-sectional flute pattern through line B-B is different than the cross-sectional flute pattern through line C-C.

FIG. 11 shows a cross-sectional flute pattern with a cutting flute 215. The cutting flute 215 defines a core having generally a tri-spoke configuration. Each of the spoke like sections of the core extends from a central portion of the core and supports cutting edges 217b. The outer surfaces 219 between the cutting edges on a spoke extend generally are known as “radial-lands.” It is noted that in some configurations, only one of the edges 219 need be a cutting edge.

The flute pattern 215 defines a core section 222a or 222b, respectively for the proximal and distal working portions, and the flute pattern may vary from one section other or generally be the same pattern.

FIG. 12 shows a cross-sectional flute pattern defined by cutting flute 215 and a cutting edges 217a. In this embodiment, the radial lands have been reduced to apices on a triangular core, which are the cutting edges 217a, and therefore do not extend circumferentially to any substantial degree. Accordingly, this configuration provides a core without radial lands

The helical flutes 215 in the embodiment shown provide helical cutting edges that extend along the long axis of the working portion continuously from one cross-sectional region 212 into another.

Although the Figures show only two different portions defining the working portion, there may be a third portion or any number of additional portions wherein such additional portions differ from an adjacent or contiguous proximal or distal portion. Therefore the use of the terms “proximal portion” and “distal portion” are not meant to imply that there are only two portions in any given file or that the portions are located at the most proximal or distal portions of a file. The advantage to multiple cross-sectional flute patterns allows for an endodontic instrument to have more strength in certain areas of the file where it is needed most and to have a more aggressive cutting flute in other areas, as persons skilled in the art will recognize from the teachings herein.

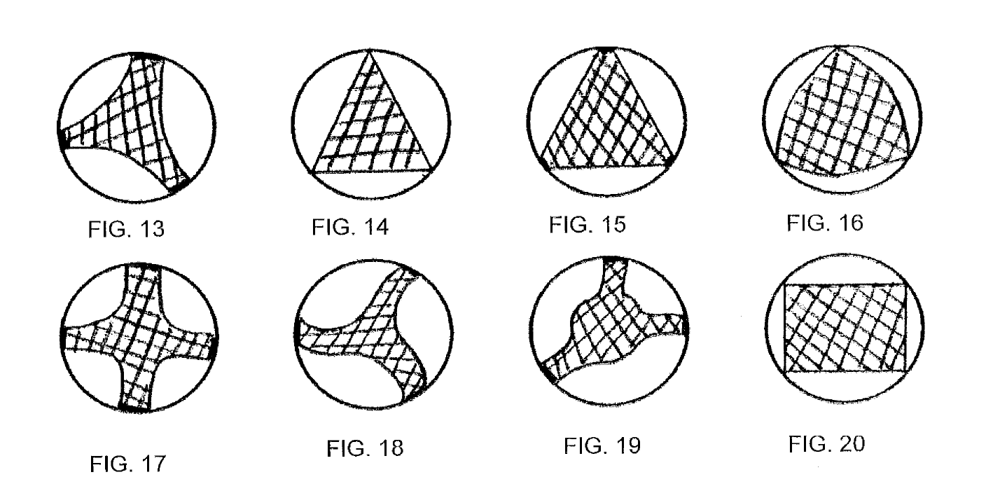

FIGS. 13-20 show many examples of cross-sectional flute patterns that persons skilled in the art will recognize to provide various properties, such as more aggressive cutting, lower torque, higher strength etc. Some are with radial lands, and some without radial lands. FIGS. 13, 15, 17, 18, and 19 show flute patterns with radial lands; FIGS. 14, 16, and 20 show flute patterns without radial lands. The cross-sectional flute patterns shown in FIGS. 13-20 are for example only and the inventive subject matter is not restricted to the cross-sectional flute patterns shown.

From the teachings herein persons skilled in the art will appreciate that the inventive files may by manufactured by using or adapting file manufacturing techniques. For example, grinding methods and machinery are disclosed in U.S. Pat. No. 5,464,362 (Heath et al.). An abrasive grinding wheel is used to remove the desired amount of material from the alloy wire stock and produces the desired cross-sectional flute shape as described in U.S. Pat. No. 5,464,362. Other manufacturing techniques, such as chemical milling and torsioning, which may be used to create certain geometries, are disclosed in U.S. Pat. No. 6,968,619, which is hereby incorporated by reference as if recited in full herein for all purposes.

Persons skilled in the art will recognize that many modifications and variations are possible in the details, materials, and arrangements of the parts and actions which have been described and illustrated in order to explain the nature of this invention and that such modifications and variations do not depart from the spirit and scope of the teachings and claims contained therein.

What is claimed:

1. An endodontic file comprising an elongated, flexible metal, the file being sized and shaped for use in a root canal procedure and having a working portion for cutting or abrading biological material, the working portion comprising at least a proximal portion and a distal portion, the proximal and distal portions having different cross-sectional flute or core patterns and associated cutting edges.

2. The endodontic file of claim 1 wherein the proximal and distal portions are contiguous to each other and the file tapers from a proximal working portion to a distal working portion.

3. The endodontic file of claim 2 wherein the cutting edges comprise a continuous helical cutting edge extending from a proximal working portion across and into the distal working portion.

4. The endodontic file of claim 1 wherein one of the proximal or distal portions has a radial land extending circumferentially and the other portion has a radial land reduced to a point.

5. The endodontic file of claim 3 wherein, cross-sectionally, one of the proximal or distal portions has a radial land extending circumferentially and the other portion has a radial land reduced to about a point.

6. The endodontic file of claim 5 wherein, cross-sectionally, the distal portion has circumferentially extending lands and the proximal portion has lands reduced to a point.

7. An endodontic file for use in root canal treatment, comprising: an elongated shank having a long axis with a proximal end connected to a handle adapted to be manipulated by hand or inserted into a rotary drive, and a working portion extending to a distal end, the working portion includes a plurality of cutting edges formed by spiraled helical flutes, of which at least two different cross-sectional helical flute patterns exist over the working portion of the file.

8. The endodontic file in claim 7, wherein the working portion has a cutting flute pattern with a radial land over one section of the working portion and a cutting flute pattern without a radial land over the remaining section of the working portion.

9. The endodontic file in claim 8, wherein the width of the radial land varies over the length of the working portion.

10. An endodontic file for use in root canal treatment, comprising: an elongated shank having a long axis with a proximal end connected to a handle adapted to be manipulated by hand or inserted into a rotary drive, and a working portion extending to a distal end, the working portion includes at least two different cross-sectional cutting edge patterns exist over the working portion of the file.
